(19) United States
(12) Patent Application Publication
(10) Pub. No.: US 2005/0162370 A1
(43) Pub. Date: Jul. 28, 2005

(54) Drive voltage generator circuit for driving LCD panel

(75) Inventor: Kiyoshi Miyazaki, Kawasaki (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KAWASAKI (JP)

(21) Appl. No.: 11/042,159

(22) Filed: Jan. 26, 2005

(30) Foreign Application Priority Data
Jan. 27, 2004 (JP) 018583/2004

(51) Int. Cl. G09G 3/36

(52) U.S. Cl. 345/98

(57) ABSTRACT

A drive voltage generator circuit is provided for developing drive voltages used for driving an LCD panel. The drive voltage generator circuit is composed of a breeder, a buffer amplifier, a switch circuitry, and a set of first to N-th output terminals on which the drive voltages are developed, respectively. The breeder develops a set of first to N-th different voltages on first to N-th nodes, respectively, N being any integer equal to or more than 2, and the first to N-th voltages being associated with grayscale levels, respectively. The switch circuitry switches connections among an input and an output of the buffer amplifier, the first to N-th nodes, and the first to N-th output terminals.

### BACKGROUND OF THE INVENTION

1. Field of the Invention

The present invention relates to drive voltage generator circuits, LCD (liquid crystal display) drivers, and liquid crystal display apparatuses. More particularly, the present invention relates to generation of drive voltages (which may be called grayscale voltages) within LCD drivers.

2. Description of the Related Art

Recent mobile electronic apparatus, such as cellular phones, often incorporate liquid crystal display apparatuses for man-machine interface. Requirements of liquid crystal display apparatuses incorporated within mobile electronic apparatuses include reduction in the circuit size and power consumption of hardware implementations. One approach for reducing the circuit size and power consumption is to incorporate a reduced number of circuitries within liquid crystal display apparatuses.

A typical liquid crystal display apparatus is composed of an LCD driver and an LCD panel. A typical LCD driver includes a grayscale voltage generator and a drive circuitry. The grayscale voltage generator generates a set of different grayscale voltages. The drive circuitry selects the grayscale voltages in response to pixel data, which are digital data representative of desired grayscale levels of the associated pixels, and outputs the selected grayscale voltages to drive the associated signal lines (or data lines) within the LCD panel.

In order to drive signal lines within an LCD panel immediately, driving the signal lines are often achieved by using buffer amplifiers incorporated within the LCD driver, which are each composed of a source follower having a gain of 1.

In a typical LCD driver configuration, as disclosed as a prior art in Japanese Laid-Open Patent Application No. P2002-108301A, buffer amplifiers are provided for respective LCD driver outputs used for providing desired drive voltages for signal lines of an LCD panel.

FIG. 1 illustrates the disclosed LCD driver structure. The disclosed LCD driver is composed of a serial-parallel shift register 1, a set of m data latches 2, a load latch circuit 3, a level shifter 4, a digital/analog (D/A) converter 5, a buffer amplifier circuit 6, and a breeder 7, m being a natural number. The buffer amplifier circuit 6 composed of a set of m buffer amplifiers 6₁ to 6ₘ, outputs of which are respectively connected to m signal lines disposed within an LCD panel through a set of m outputs terminals of the LCD driver.

The shift register 1 is used to develop a set of m latch signals in response to an externally inputted shift pulse signal and transfer clock. The shift register 1 sequentially latches and shifts data bits of the shift pulse signal in synchronization with a transfer clock, and thereby develops the set of m latch signals on the parallel outputs.

The data latches 2 are each designed to latch the associated pixel data in synchronization with the associated latch signal.

The load latch circuit 3 latches the outputs of the data latches 2 in response to a load signal at the same timing.

The level shifter 4 provides level shifting between the outputs of the load latch circuit 3 and the inputs of the D/A converter 5.

The breeder 7 divides an external voltage by using a set of serially connected resistors, and thereby generates a set of n (=2^{k}) different grayscale voltages, k being a natural number.

The D/A converter 5 selects one of the grayscale voltages for each signal line in response to the associated pixel data.

The buffer amplifiers 6₁ to 6ₘ receive the associated grayscale voltages from the D/A converter 5, and provide buffering for the received grayscale voltages to develop a set of drive voltages. The drive voltages outputted from the buffer amplifiers 6₁ to 6ₘ are substantially identical to the associated grayscale voltages, received from the D/A converter 5. The drive voltages are outputted to the signal lines of the LCD panel.

One drawback of this LCD driver architecture is that this LCD driver architecture requires increasing the number of the buffer amplifiers 6₁ to 6ₘ for increasing the number of the outputs of the LCD driver. Increasing the screen size and/or fineness of the liquid crystal panel requires increasing the number of the signal lines of the liquid crystal panel, that is, the number of the buffer amplifiers disposed within the LCD driver. The increased number of the buffer amplifiers undesirably increases the circuit size and power consumption of the LCD driver.

In order to solve this drawback, an improved LCD driver structure has been proposed in the aforementioned Japanese Laid-Open Patent Application No. P2002-108301A, which incorporates one buffer amplifier for each grayscale voltage. This effectively allows increasing the number of LCD driver outputs without increasing the number of buffer amplifiers.

FIGS. 2 and 3 illustrate the proposed LCD driver structure. Referring to FIG. 2, the disclosed LCD driver is composed of a serial-parallel shift register 1, a set of m data latches 2, a load latch circuit 3, a level shifter 4, a decoder circuit 21, an output selector circuit 22, a buffer amplifier circuit 6, and a breeder 7; it should be noted that same numerals denote the same, similar, or equivalent elements in the specification. The disclosed LCD driver additionally includes a pixel data enable circuit 23, a pixel mode circuit 24, and an amplifier enable circuit 25.

As shown in FIG. 3, the buffer amplifier circuit 6 and the breeder 7 constitute a drive voltage generator circuit 10 that generates a set of drive voltages associated with grayscale levels, while the load latch circuit 3, the decoder circuit 21, and the output selector circuit 22 constitute a drive circuitry 20 designed to output a selected one of the drive voltages on each output terminal.

The breeder 7 is composed of a set of resistor elements R₀ to Rₙ serially connected between the power supply V_{H} and ground V_{L} to generate n different grayscale voltages associated with different grayscale levels; n is the number of available grayscale levels, equal to 2^{k}, where k is the number of data bits of each pixel data. The resistor element R_{w} is connected to the adjacent resistor element R_{w-1} with a node TP_{w} disposed therebetween, where w is any integer ranging from 1 to n. Such connection provides different voltages on the nodes TP₁ to TPₙ; the voltages developed on the nodes TP₁ to TPₙ are denoted by numerals V₁ to Vₙ, respectively.

The buffer amplifier circuit 6 includes a set of n buffer amplifiers AM₁ to AMₙ each having a gain of 1. The inputs of the buffer amplifiers AM₁ to AMₙ are connected to the node TP₁ to Tpₙ, respectively. The buffer amplifiers AM₁ to AMₙ provide buffering for the grayscale voltages received from the nodes TP₁ to TPₙ, respectively. The buffer amplifiers AM₁ to AMₙ develops drive voltages on the output terminals, denoted by numerals LV₁ to LV₁, respectively. The drive voltages developed on the output terminals LV₁ to LVₙ are ideally identical to the voltages V₁ to Vₙ developed on the nodes TP₁ to TPₙ, respectively. The drive voltages developed on the output terminals LV₁ to LVₙ are used for driving the signal lines of the LCD panel, denoted by numeral 30 in FIG. 3.

The load latch circuit 3 is composed of a set of m latches 3₁ to 3ₘ, and the decoder circuit 21 is composed of a set of m decoders 21₁ to 21ₘ. Additionally, the output selector circuit 22 is composed of a set of multiplexers 22₁ to 22ₘ that functions as D/A converters. The outputs of the latches 3₁ to 3ₘ are connected to the inputs of the decoders 21₁ to 21ₘ, respectively. The outputs of the decoders 21₁ to 21ₘ are connected to the select inputs of the multiplexers 22₁ to 22ₘ, respectively. The outputs of the multiplexers 22₁ to 22ₘ are connected to the output terminals of the LCD driver, which are denoted by symbols OUT₁ to OUTₘ, respectively. The output terminals OUT₁ to OUTₘ are connected to the signal lines of the LCD panel 30.

The latches 3₁ to 3ₘ latch externally inputted k-bit pixel data D₁ to Dₘ, respectively, in synchronization with an externally inputted transfer clock CLK. The latched k-bit pixel data D₁ to Dₘ are provided for the decoders 21₁ to 22ₘ.

The decoders 21₁ to 22ₘ decode the pixel data D₁ to Dₘ.

The multiplexers 22₁ to 22ₘ are each designed to select among the voltages V₁ to Vₙ developed on the output terminals LV₁ to LVₙ in response to the decoded pixel data D₁ to Dₘ, respectively. When a pixel data Dᵥ is “111111” with k=6, v being a natural number ranging from 1 to n, the multiplexer 22ᵥ selects the voltage Vₙ out of the voltages V₁ to Vₙ. When a pixel data Dᵥ is “000000”, on the other hand, the multiplexer 22ᵥ selects the voltage V₁ out of the voltages V₁ to Vₙ. The multiplexers 22₁ to 22ₘ provide the selected voltages for the LCD panel 30 through the associated output terminals OUT₁ to OUTₘ.

An advantageous feature of the LCD driver structure shown in FIG. 3 is that the LCD driver is allowed to have an increased number of output terminals without increasing the number of the buffer amplifiers; the number of the buffer amplifiers is limited to the number of the available grayscale levels.

Recent requirements include the increase in the number of available grayscale levels; however, the LCD driver structure shown in FIG. 3 suffers from a problem that the number of the buffer amplifiers is increased in proportion to the number of available grayscale levels. In order to achieve 260k-color display, for example, the LCD driver structure shown in FIG. 3 requires 64 buffer amplifiers; it should be noted that 260k-color display requires 64 grayscale levels for each R, G, B color component. The LCD driver structure shown in FIG. 3 requires 256 or 1024 buffer amplifiers for achieving natural grayscale display, involving 256 (=2⁸) or 1024 (2₁₆) grayscale levels for each R, G, B color component. As described above, the LCD driver structure shown in FIG. 3 requires increasing the number of the buffer amplifiers for increasing the number of available grayscale levels. This undesirably increases the circuit size and power consumption of the hardware implementation of the LCD driver.

Japanese Laid Open Patent Application No. P2000-98331A discloses another LCD driver structure for reducing the number of voltage followers within an LCD driver; however, this LCD driver structure addresses achieving frame-inversion driving of LCD segment display panels with a reduced number of voltage followers, and does not provide grayscale display.

### SUMMARY OF THE INVENTION

In an aspect of the present invention, a drive voltage generator circuit is provided for developing drive voltages used for driving an LCD panel. The drive voltage generator circuit is composed of a breeder, a buffer amplifier, a switch circuitry, and a set of first to N-th output terminals on which the drive voltages are developed, respectively. The breeder develops a set of first to N-th different voltages on first to N-th nodes, respectively, N being any integer equal to or more than 2, and the first to N-th voltages being associated with grayscale levels, respectively. The switch circuitry switches connections among an input and an output of the buffer amplifier, the first to N-th nodes, and the first to N-th output terminals.

This architecture of the drive voltage generator circuit only requires one buffer amplifier for developing N drive voltages associated with N different grayscale levels, and therefore effectively reduces the number of buffer amplifiers for driving the LCD panel. This effectively reduces the power consumption and circuit size of the LCD driver.

### BRIEF DESCRIPTION OF THE DRAWINGS

FIG. 1 is a block diagram illustrating a conventional LCD driver structure;

FIG. 2 is a block diagram illustrating another conventional LCD driver structure;

FIG. 3 is a detailed block diagram illustrating the conventional LCD driver structure shown in FIG. 2;

FIG. 4 is a block diagram illustrating an exemplary structure of an LCD driver in a first embodiment;

FIGS. 5A and 5B are circuit diagrams illustrating an exemplary structure and operation of a buffer circuitry disposed within the LCD driver in the first embodiment;

FIG. 6 is a timing chart illustrating the operation of the buffer circuitry in the first embodiment;

FIG. 7 is a block diagram illustrating an exemplary structure of an LCD driver in a second embodiment;

FIGS. 8A to 8C are circuit diagrams illustrating an exemplary structure and operation of a buffer circuitry disposed within the LCD driver in the second embodiment;

FIG. 9 is a timing chart illustrating the operation of the buffer circuitry in the first embodiment;

FIG. 10 is a block diagram illustrating an exemplary structure of an LCD driver in a third embodiment;

FIGS. 11A to 11C are circuit diagrams illustrating an exemplary structure and operation of a buffer circuitry disposed within the LCD driver in the third embodiment;

FIG. 12 is a timing chart illustrating the operation of the buffer circuitry in the third embodiment;

FIG. 13 is a circuit diagram illustrating a preferred structure of the buffer circuitry in the first embodiment;

FIG. 14 is a circuit diagram illustrating a preferred structure of the buffer circuitry in the second embodiment; and

FIG. 15 is a timing chart illustrating a preferred operation of the buffer circuitry in the second embodiment.

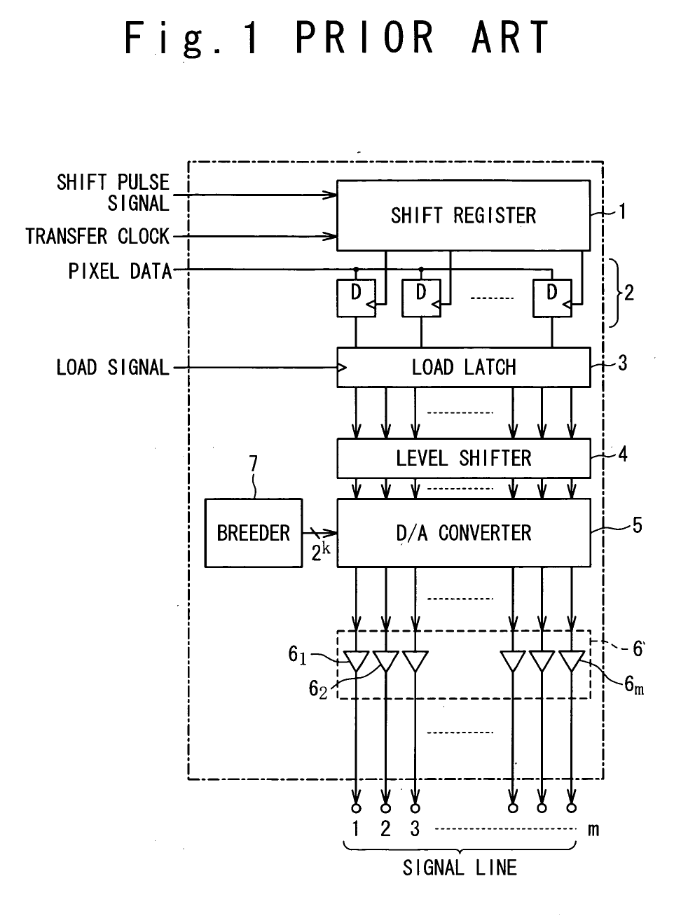

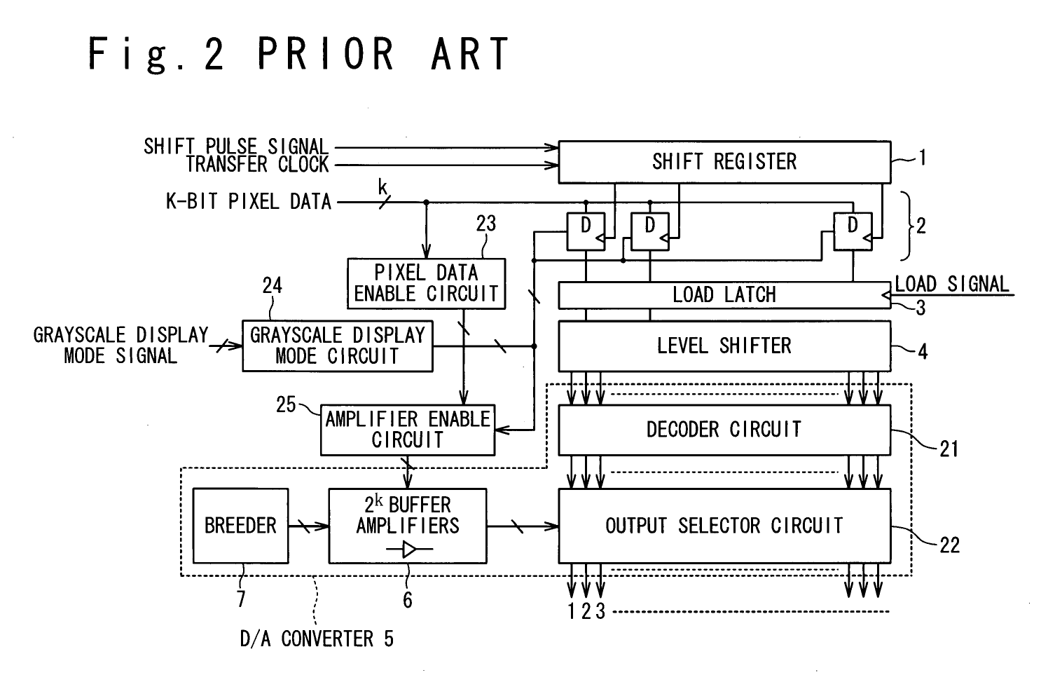

### DESCRIPTION OF THE PREFERRED EMBODIMENTS

Preferred embodiments of the present invention will be described in detail with reference to the attached drawings. It should be noted that same numerals denote same, or like components in the attached drawings.

### First Embodiment

(System Structure)

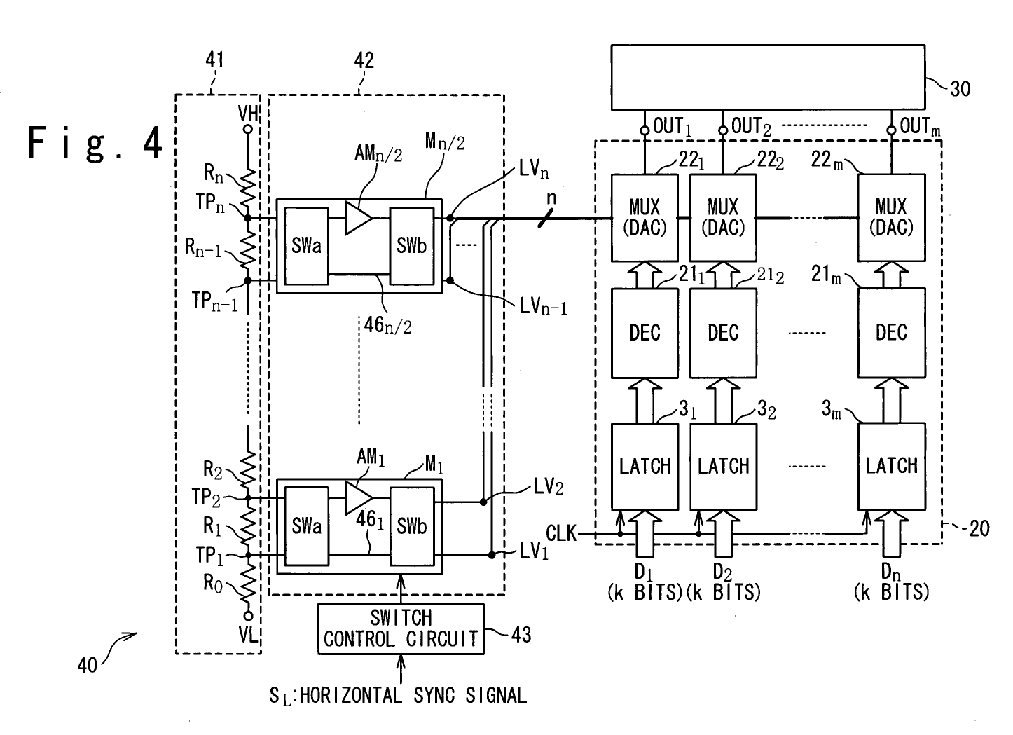

In a first embodiment, as illustrated in FIG. 4, a liquid crystal display apparatus is composed of an LCD panel 30, and an LCD driver including a drive voltage generator circuit 40 and a driver circuitry 20. The driver circuitry 20 is connected to the drive voltage generator circuit 40 and also to the LCD panel 30.

The drive voltage generator circuit 40 is composed of a breeder (voltage generator) 41, and a buffer circuitry 42, and a switch control circuit 43.

The breeder 41 is comprised of a set of resistor elements R₀ to Rₙ serially connected between the power supply V_{H} and ground V_{L} to generate n different voltages associated with grayscale levels; n being the number of available grayscale levels, equal to 2^{k}, where the k is the number of data bits of each pixel data. The resistor element Rⱼ is connected to the adjacent resistor element Rⱼ₋₁ with a node TPⱼ disposed therebetween, and the resistor element Rⱼ₋₁ is connected to the adjacent resistor element Rⱼ₋₂ with a node TPⱼ₋₁, where j is any even number equal to or less than n. Such connection provides different voltages on the nodes TP₁ to TPₙ; the voltages developed on the nodes TP₁ to TPₙ are denoted by numerals V₁ to Vₙ, respectively. It should be noted that the voltages V₁ to Vₙ satisfy the following relation:
V₁<V₂< . . . <Vₙ.

The buffer circuitry 42 is composed of a set of n/2 buffer modules M₁ to M_{n/2}, each including an input switch module SWa, an output switch module SWb, and a buffer amplifier; the buffer amplifier within the buffer module M_{j/2} is denoted by numeral AM_{j/2}, hereinafter. Inputs of the input switch module SWa of the buffer module M_{j/2} are connected to the nodes TPⱼ and TPⱼ₋₁. An output of the input switch module SWa of the buffer module M_{j/2} is connected to an input of the buffer amplifier AM_{j/2}. An output of the buffer amplifier AM_{j/2} is connected to an input of the output switch module SWb. Another input of the output switch module SWb is connected to the node TPⱼ₋₁ through a bypass line 46_{j/2} and the input switch module SWa. Outputs of the output switch module SWb within the buffer amplifier AM_{j/2} are connected to output terminals LVⱼ and LVⱼ₋₁ of the buffer circuitry 42. The output terminals LV₁ to LVₙ are connected to the drive circuitry 20 through a set of n signal lines.

The switch control circuit 43 is responsive to an externally inputted horizontal sync signal S_{L} for providing a switch control signal for each of the input and output switch modules SWa and SWb within each buffer module. The horizontal sync signal S_{L} is indicative of the beginning of each horizontal period; the horizontal sync signal S_{L} is activated at the beginning of each horizontal period. The duration of each horizontal period is referred to as 1H, hereinafter. The input switch module SWa within the buffer module M_{j/2} switches connections among the nodes TPⱼ, TPⱼ₋₁, and the input of the buffer amplifier AM_{j/2} in response to the associated switch control signal received from the switch control circuit 43. The buffer amplifier AM_{j/2} provide buffering for the output of the input switch module SWa within the buffer module M_{j/2}. The output switch module SWb within the buffer module M_{j/2} switches connections among the output terminals LVⱼ, LVⱼ₋₁, the bypass line 46_{j/2}, and the output of the buffer amplifier AM_{j/2}, in response to the associated switch control signal received from the switch control circuit 43.

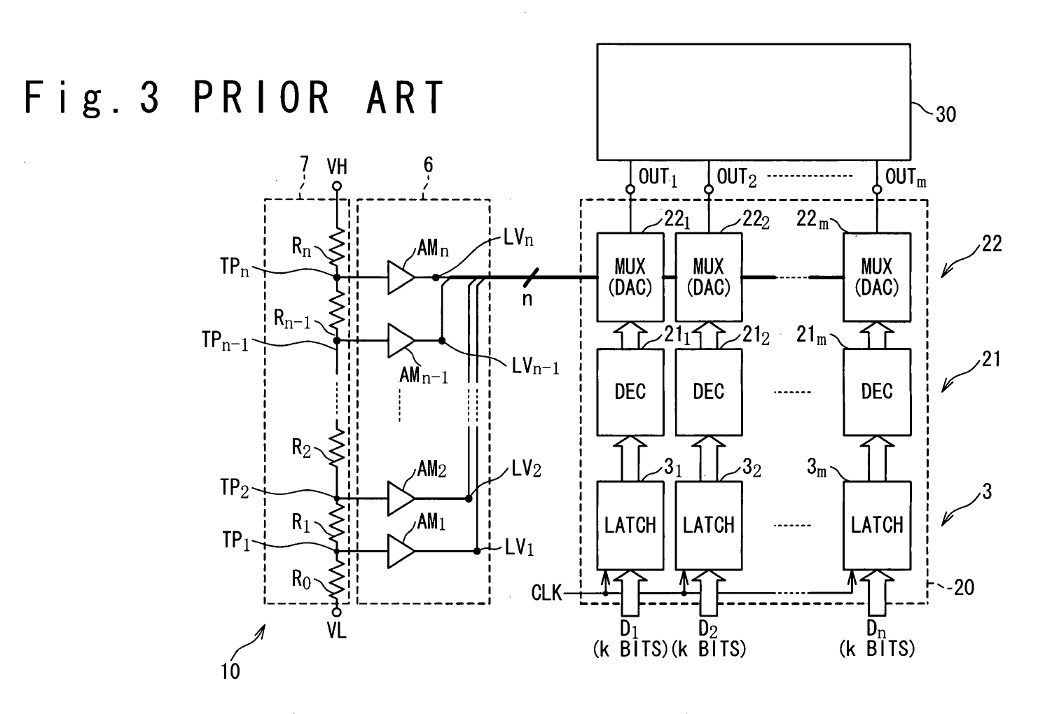

The structure of the drive circuitry 20, on the other hand, is similar to that shown in FIG. 3. Specifically, the drive circuitry 20 is composed of a set of m latches 3₁ to 3ₘ, a set of m decoders 21₁ to 21ₘ, and a set of multiplexers 22₁ to 22ₘ that functions as D/A converters. The outputs of the latches 3₁ to 3ₘ are connected to the inputs of the decoders 21₁ to 21ₘ, respectively. The outputs of the decoders 21₁ to 21ₘ are connected to the select inputs of the multiplexers 22₁ to 22ₘ, respectively. The outputs of the multiplexers 22₁ to 22ₘ are connected to the output terminals of the LCD driver, which are denoted by symbols OUT₁ to OUTₘ, respectively. The output terminals OUT₁ to OUTₘ are connected to the signal lines of the LCD panel 30. The latches 3₁ to 3ₘ latch externally inputted k-bit pixel data D₁ to Dₘ, respectively, in synchronization with an externally inputted transfer clock CLK. The clock CLK is synchronous with the horizontal sync signal S_{L}. The latched k-bit pixel data D₁ to Dₘ are provided for the decoders 21₁ to 22ₘ. The decoders 21₁ to 22ₘ decode the pixel data D₁ to Dₘ.

The multiplexers 22₁ to 22ₘ are each designed to select among the voltages V₁ to Vₙ developed on the output terminals LV₁ to LVₙ in response to the decoded pixel data D₁ to Dₘ, respectively. When a pixel data Dᵥ is “111111” with k=6, v being a natural number ranging from 1 to n, for example, the multiplexer 22ᵥ selects the voltage Vₙ out of the voltages V₁ to Vₙ. When a pixel data Dᵥ is “000000”, on the other hand, the multiplexer 22ᵥ selects the voltage V₁ out of the voltages V₁ to Vₙ. The multiplexers 22₁ to 22ₘ provide the selected voltages for the LCD panel 30 through the associated output terminals OUT₁ to OUTₘ, respectively.

(Arrangement and Operation of Buffer Modules)

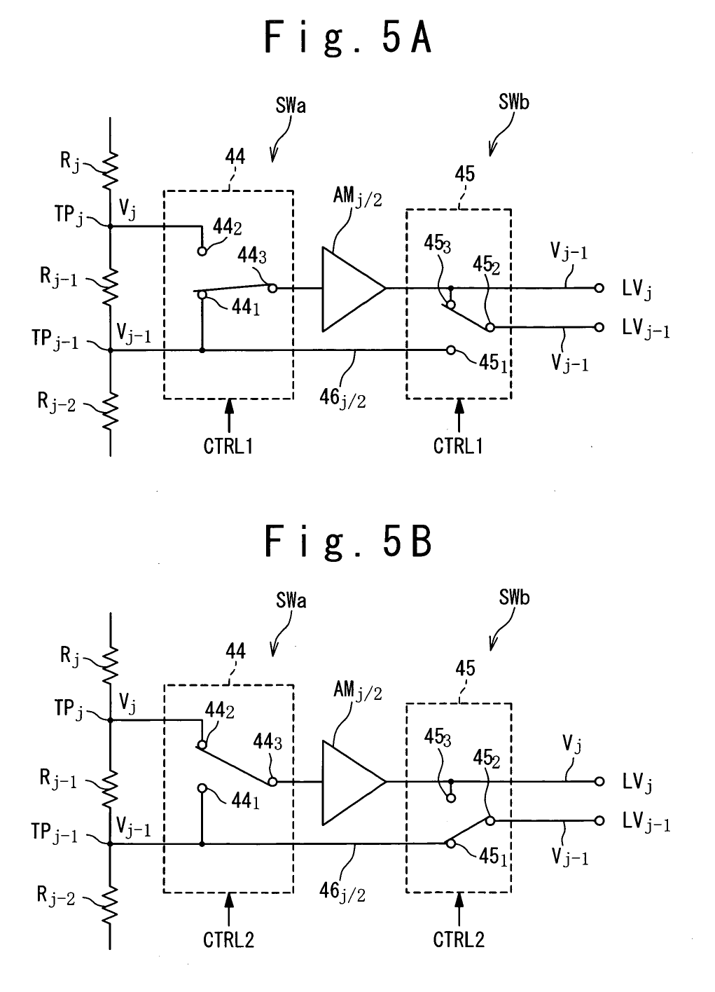

FIGS. 5A and 5B illustrate an exemplary arrangement of the buffer modules M₁ to M_{n/2}.

The input switch module SWa within the buffer module M_{j/2} is composed of a switch 44 having first to third terminals 44₁ to 44₃. The first terminal 44₁ receives the voltage Vⱼ₋₁ from the node TPⱼ₋₁, while the second terminal 44₂ receives the voltage Vⱼ from the node TPⱼ. The third terminal 44₃ is connected to the input of the buffer amplifier AM_{j/2}. The switch 44 connects selected one of the first and second terminals 44₁ and 44₂ to the third terminal 44₃.

The output switch module SWb, on the other hand, has a switch 45 having first to third terminals 45₁ to 45₃. The first terminal 45₁ is connected to the node TPⱼ₋₁ through the bypass line 46_{j/2}, and directly receives the voltage Vⱼ₋₁ from the node TPⱼ₋₁. The second terminal 45₂ is connected to the output terminal LVⱼ₋₁. The third terminal 45₃ is connected to the output of the buffer amplifier AM_{j/2}. The output of the buffer amplifier AM_{j/2} is also directly connected to the output terminal LVⱼ.

One feature of this arrangement is that the buffer module M_{j/2} uses the buffer amplifier AM_{j/2} for driving both of the output terminals LVⱼ and LVⱼ₋₁. Using one buffer amplifier for driving multiple output terminals of the drive voltage generator circuit 40 effectively reduces the number of the buffer amplifiers within the LCD driver.

Another feature is that the buffer module M_{j/2} provides step-by-step driving for the output terminal that is latterly driven. This effectively suppress over-shoot of the voltage on the output terminal LVⱼ.

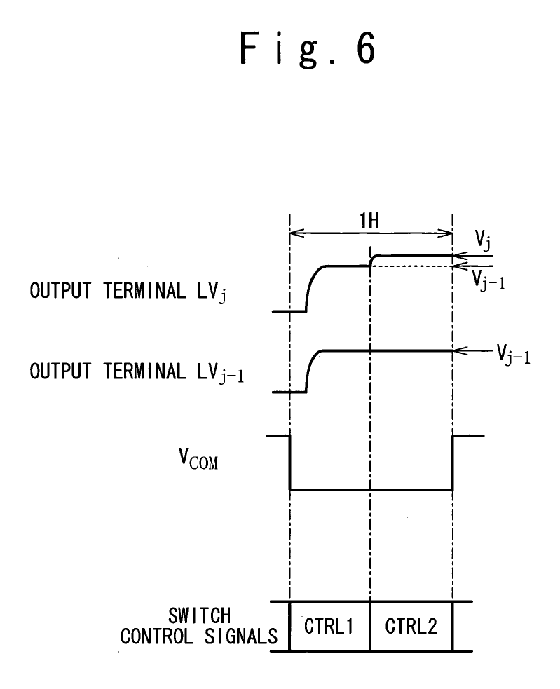

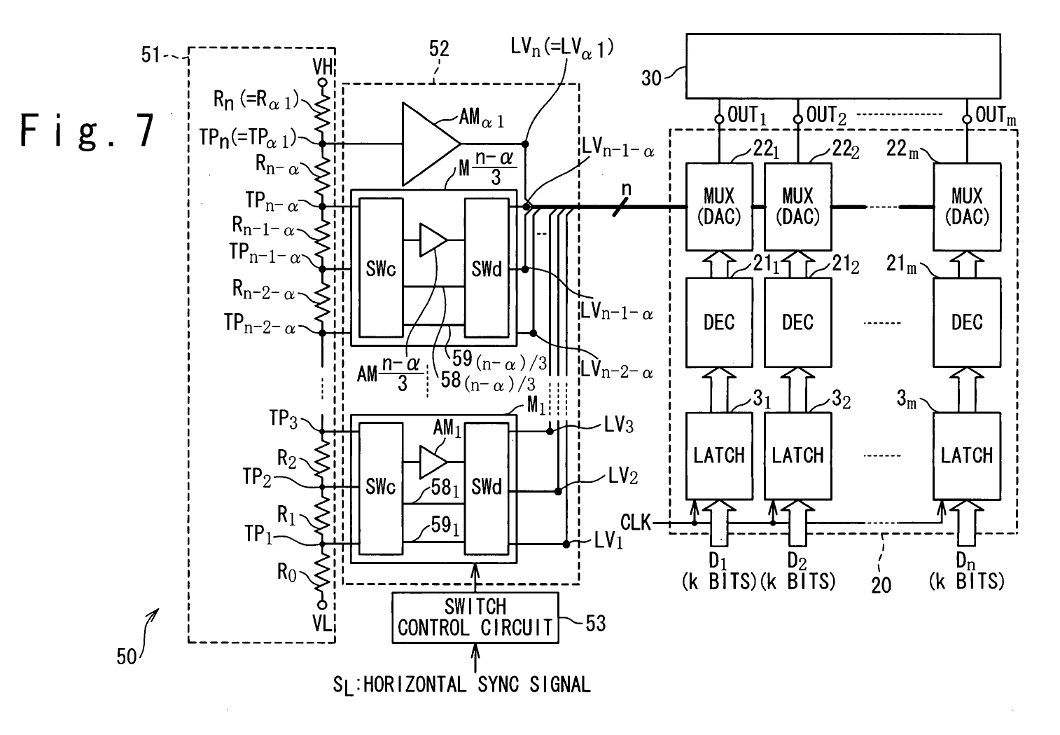

More specifically, the buffer module M_{j/2} functions as follows. FIG. 6 is a timing chart illustrating an exemplary operation of the buffer module M_{j/2} and the switch control circuit 43.

When a horizontal period is initiated, as shown in FIG. 6, the horizontal sync signal S_{L} is activated, and the voltage on the common electrode of the LCD panel 30 (referred to as the common voltage V_{COM}, hereinafter) is switched; the common voltage V_{COM} is pull down to ground in this operation.

In response to the activation of the horizontal sync signal S_{L}, the switch control circuit 43 switches the switch control signals provided for the input and output switch modules SWa and SWb within the buffer module M_{j/2} to a first state, referred to as the state “CTRL1”, at the beginning of the first half of the horizontal period.

In response to the associated switch control signal being placed into the state “CTRL1”, as shown in FIG. 5A, the switch 44 within the input switch module SWa connects the first terminal 44₁ with the third terminal 44₃, and thereby provides a connection between the node TPⱼ₋₁ and the input of the buffer amplifier AM_{j/2}.

Additionally, the switch 45 within the output switch module SWb connects the second terminal 45₂ with the third terminal 45₃ in response to the associated switch control signal being placed into the state “CTRL1”. In other words, the output switch module SWb provides a connection between the output of the buffer amplifier AM_{j/2} and the output terminal LVⱼ₋₁.

As shown in FIG. 6, this results in that both of the output terminals LVⱼ₋₁ and LVⱼ are driven to the voltage Vⱼ₋₁ by the buffer amplifier AM_{j/2}, during the first half of the horizontal period.

The switch control circuit 43 then switches the switch control signals to a second state, referred to as the state “CTRL2”, at the beginning of the latter half of the horizontal period.

In response to the associated switch control signal being switched to the state “CTRL2”, as shown in FIG. 5B, the switch 44 within the input switch module SWa connects the second terminal 44₂ with the third terminal 44₃, and thereby provides a connection between the node TPⱼ and the input of the buffer amplifier AM_{j/2}.

Additionally, the switch 45 within the output switch module SWb connects the second terminal 45₂ with the first terminal 45₁ in place of the third terminal 45₃, in response to the associated switch control signal being placed into the state “CTRL2”. In other words, the output switch module SWb provides a connection between the output terminal LVⱼ₋₁ and the node TPⱼ₋₁ through the bypass line 46_{j/2}, disconnecting the output of the buffer amplifier AM_{j/2} from the output terminal LVⱼ₋₁.

As shown in FIG. 6, this results in that the output terminal LVⱼ is pulled up to the voltage Vⱼ from the voltage Vⱼ₋₁ during the latter half of the horizontal period, while the voltage developed on the output terminal LVⱼ₋₁ is maintained at the voltage Vⱼ₋₁ through connecting the output terminal LVⱼ₋₁ to the node TPⱼ₋₁ through the bypass line 46_{j/2}.

It should be noted that driving the output terminals LV₁ to LVₙ to the voltages V₁ to Vₙ is only required to be complete by the end of the horizontal period. Although the step-by-step driving may cause a specific signal line to be driven to an undesirable voltage at the middle of the horizontal period, it does not affect the grayscale level finally represented on the pixels of the LCD panel 30 at the end of the horizontal period, because the aforementioned step-by-step driving allows the multiplexers 21₁ to 21ₘ to receive the voltages V₁ to Vₙ as required at the end of the horizontal period, and to develop the desired voltages on the respective signal lines.

The order in which the voltages Vⱼ and Vⱼ₋₁ are developed on the outputs terminals LVⱼ and LVⱼ₋₁ is preferably dependent on the level of the common voltage V_{COM}, developed on the common electrode of the LCD panel 30. As described above, for a horizontal period during which the common voltage V_{COM} is pulled down to ground, the input switch module SWa selects the voltage Vⱼ₋₁ to output to the input of the buffer amplifier AM_{j/2} during the first half of the horizontal period, and then selects the voltage Vⱼ during the latter half of the horizontal period.

For a horizontal period during which the common voltage V_{COM} is pulled up to a power supply voltage, higher than the voltage Vₙ, the order in which the voltages Vⱼ and Vⱼ₋₁ are selected by the input switch module SWa is reversed.

Specifically, the input switch module SWa selects the voltage Vⱼ during the first half of the horizontal period, while the output switch module SWb provides connections between the output of the buffer amplifier AM_{j/2} and both of the output terminals LVⱼ₋₁ and LVⱼ. This results in that both of the output terminals LVⱼ₋₁ and LVⱼ are driven to the voltage Vⱼ.

During the latter half of the horizontal period, the input switch module SWa selects the voltage Vⱼ₋₁, while the output switch module SWb provides a connection between only the output terminal LVⱼ₋₁ and the output of the buffer amplifier AM_{j/2}; the output terminal LVⱼ is disconnected from the output of the buffer amplifier AM_{j/2}, and directly connected to the node TPⱼ through an additional bypass line. This results in that the output terminals LVⱼ₋₁ is driven to the voltage Vⱼ₋₁ with the output terminal LVⱼ maintained at the voltage Vⱼ.

In summary, the LCD driver architecture in this embodiment effectively reduces the power consumption and circuit size through reducing the number of necessary buffer amplifiers. Although the architecture in this embodiment additionally incorporates the set of input and output switch modules SWa and SWb, the input and output switch modules SWa and SWb can be implemented with reduced hardware implementations due to the simplicity.

Additionally, the LCD driver architecture in this embodiment effectively avoids over-shoot of the voltages on the output terminals of the drive voltage generator circuit 40 through adopting step-by-step driving.

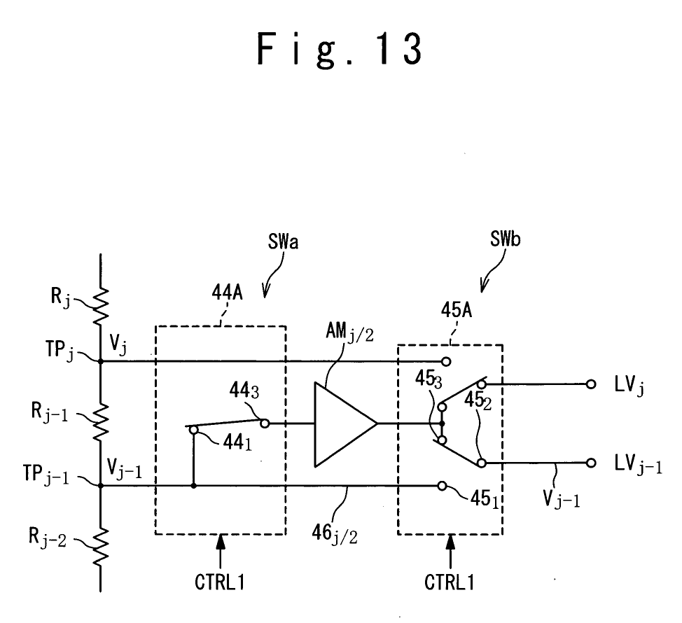

In an alternative embodiment, the structure of the input and output switch modules SWa and SWb of the buffer module M_{j/2} may be modified as shown in FIG. 13. In the structure shown in FIG. 13, the input switch module SWa within the buffer module M_{j/2} is composed of a switch 44A that is responsive to the control signal received from the switch control circuit 43 for providing an electrical connection between the node TPⱼ₋₁ and the input of the buffer amplifier AM_{j/2}. The output switch module SWb is composed of a switch 45A that is responsive to the control signal received from the switch control circuit 43 for providing electrical connections among the nodes TPⱼ₋₁, and TPⱼ, the output of the buffer amplifier AM_{j/2}, and the output terminals LVⱼ and LVⱼ₋₁. The switch 45A is designed to electrically connect selected one of the nodes TPⱼ₋₁ and the output of the buffer amplifier AM_{j/2} to the output terminal LVⱼ₋₁, and also to electrically connect selected one of the nodes TPⱼ and the output of the buffer amplifier AM_{j/2} to the output terminal LVⱼ.

The buffer module M_{j/2} of FIG. 13 operates as follows. The operation of the buffer module M_{j/2} of FIG. 13 divides each horizontal period into first and second periods; the first period begins at the beginning of each horizontal period, and the second period follows the first period. During the first period, the switch 44A within the input switch module SWa establish an electrical connection between the node TPⱼ₋₁ to the input of the buffer amplifier AM_{j/2}, and the output switch module SWb establishes electrical connections between the output of the buffer amplifier AM_{j/2} and the output terminals LVⱼ₋₁ and LVⱼ. This results in that both of the output terminals LVⱼ₋₁ and LVⱼ are driven to the voltage Vⱼ₋₁ by the buffer amplifier AM_{j/2}, during the first period.

During the second period, the switch 44A disconnects the node TVⱼ₋₁ from the input of the buffer amplifier AM_{j/2}, and the switch 54A establishes an electrical connection between the node TVⱼ₋₁ and the output terminal LVⱼ₋₁, and also establishes another electrical connection between the node TVⱼ and the output terminal LVⱼ; the output of the buffer amplifier AM_{j/2} is disconnected from both of the output terminals LVⱼ₋₁ and LVⱼ This results in that the output terminal LVⱼ is driven to the voltage Vⱼ with the output terminal LVⱼ₋₁ maintained at the voltage Vⱼ₋₁.

This operation advantageously achieves further reduction in the power consumption. The aforementioned operation allows the buffer amplifier AM_{j/2} to be disenabled during the second period. This effectively reduces the power consumption of the buffer module M_{j/2}.

It is preferable that the duration of the second period, during which the buffer amplifier AM_{j/2} is disconnected from both of the output terminals LVⱼ₋₁ and LVⱼ, is longer than that of the first period. This is because driving the output terminal LVⱼ to the voltage Vⱼ without using the buffer amplifier AM_{j/2} requires longer duration compared to the duration necessary for driving the output terminals LVⱼ₋₁ and LVⱼ using the buffer amplifier AM_{j/2}. In an exemplary operation, the duration of the first period is one-fifth of that of the horizontal period, while the duration of the second period is four-fifth of that of the horizontal period.

### Second Embodiment

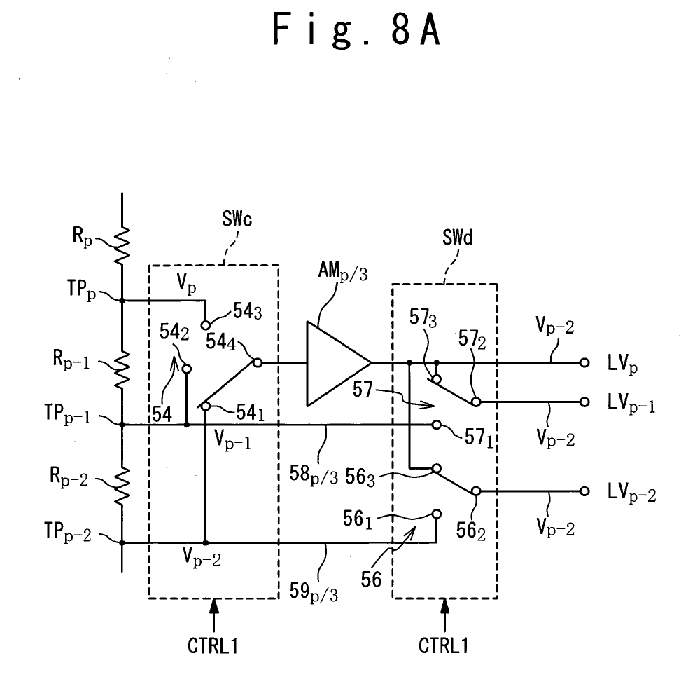

FIG. 7 illustrates an exemplary structure of a liquid crystal display apparatus in a second embodiment. The structure liquid crystal display apparatus in the second embodiment is similar to that in the first embodiment, except for that the arrangement of the drive voltage generator circuit, denoted by numeral 50. The major difference is that the drive voltage generator circuit 50 uses one buffer amplifier for driving each three output terminals. A detailed description of an exemplary structure and operation of the drive voltage generator circuit 50 is given in the following.

The drive voltage generator circuit 50 is composed of a breeder 51, a buffer circuitry 52, and a switch control circuit 53.

The breeder 51 is comprised of a set of serially connected resistors R₀ to Rₙ between the power supply V_{H} and ground V_{L} to generate n different voltages associated with grayscale levels; n being the number of available grayscale levels, equal to 2^{k}, where the k is the number of data bits of each pixel data. The resistor element R_{w} is connected to the adjacent resistor element R_{w-1} with a node TP_{w} disposed therebetween, where w is any integer ranging from 1 to n. Such connection provides different voltages V₁ to Vₙ on the nodes TP₁ to TPₙ. It should be noted that the voltages V₁ to Vₙ satisfy the following relation:
V₁<V₂< . . . <Vₙ.

The buffer circuitry 52 is composed of (n−α)/3 buffer modules M₁ to M_{(n-α)/3}, and one or two additional buffer amplifiers having a gain of 1; α is the remainder obtained by dividing n by 3. The number of the additional buffer amplifier(s) is identical to the remainder α. In this embodiment, one buffer amplifier AM_{α1} is provided for the buffer circuitry 52 with n=64, and α=1.

The input of the buffer amplifier AM_{α1} is connected to the node TPₙ, and the output of the buffer amplifier AM_{α1} is connected to the output terminal LVₙ. The buffer amplifier AM_{α1} provides buffering for the voltage Vₙ received from the node TPₙ to develop the voltage ideally identical to the voltage Vₙ on the output terminal LVₙ.

The buffer modules M₁ to M_{(n-α)/3} are each composed of an input switch module SWc, an output switch module SWd, and a buffer amplifier having a gain of 1; the buffer amplifier within the buffer module M_{p/3} is denoted by numeral AM_{p/3}, hereinafter, where p is any multiple of 3 less than n, that is, p is any number selected out of 3, 6, . . . , n−α. Inputs of the input switch module SWc of the buffer module M_{p/3} are connected to the nodes TPₚ, TPₚ₋₁ and TPₚ₋₂. An output of the input switch module SWc is connected to an input of the buffer amplifier AM_{p/3}. An output of the buffer amplifier AM_{p/3} is connected to an input of the output switch module SWd. Other two inputs of the output switch module SWd are connected to the nodes TPₚ₋₁ and TPₚ₋₂ through a pair of bypass lines 58_{p/3}, 59_{p/3}, and the input switch module SWc. Outputs of the output switch module SWd within the buffer amplifier AM_{p/3} are connected to output terminals LVₚ, LVₚ₋₁, and LVₚ₋₂ of the buffer circuitry 42. The output terminals LV₁ to LVₙ are connected to the drive circuitry 20 through a set of n signal lines.

The switch control circuit 53 is responsive to an externally inputted horizontal sync signal S_{L} for providing a switch control signal for each of the input and output switch modules SWc and SWd within each buffer module. The input switch module SWc within the buffer module M_{p/3} switches connections among the nodes TPₚ, TPₚ₋₁, TPₚ₋₂, and the input of the buffer amplifier AM_{p/3}, in response to the associated switch control signal received from the switch control circuit 53. The buffer amplifier AM_{p/3} provide buffering for the output of the input switch module SWc within the buffer module M_{p/3}. The output switch module SWd within the buffer module M_{p/3} switches connections among the output terminals LVₚ, LVₚ₋₁, LVₚ₋₂, the bypass lines 58_{p/3}, 59_{p/3}, and the output of the buffer amplifier AM_{p/3}, in response to the associated switch control signal received from the switch control circuit 53.

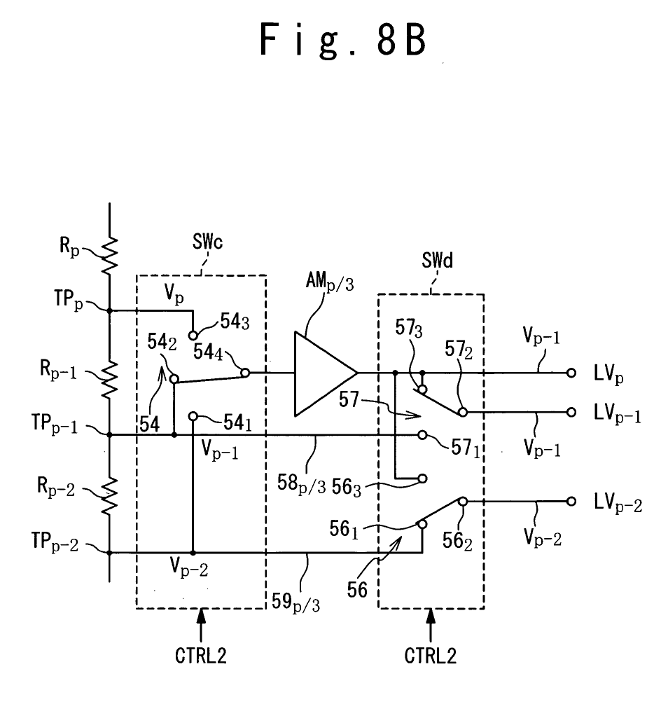

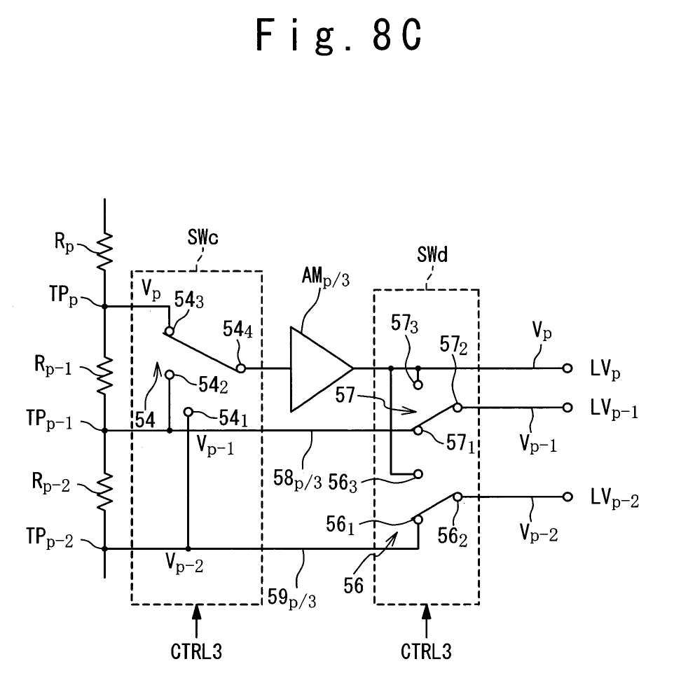

FIGS. 8A to 8C illustrate an exemplary structure of the buffer module M_{p/3}. The input switch module SWc within the buffer module M_{p/3} is composed of a switch 54 having first to fourth terminals 54₁ to 54₃. The first terminal 54₁ receives the voltage Vₚ₋₂ from the node TPₚ₋₂, and the second terminal 54₂ receives the voltage Vₚ₋₁ from the node TPₚ₋₁. Furthermore, the third terminal 54₃ received the voltage Vₚ from the node TPₚ. The fourth terminal 54₄, on the other hand, is connected to the input of the buffer amplifier AM_{p/3}. The switch 54 connects selected one of the first to third terminals 54₁ and 54₃ to the fourth terminal 54₄.

The output switch module SWd, on the other hand, is composed of a pair of switches 56 and 57, each having three terminals; the switch 56 has first to third terminals 56₁ to 56₃, and the switch 57 has first to third terminals 57₁ to 57₃. The first terminal 56, of the switch 56 is connected to the node TPₚ₋₂ through the bypass line 59_{p/3}, and directly receives the voltage Vₚ₋₂ from the node TPₚ₋₂. The second terminal 56₂ is connected to the output terminal LVₚ₋₂. The third terminal 56₃ is connected to the output of the buffer amplifier AM_{p/3}. The first terminal 57, of the switch 57, on the other hand, is connected to the node TPₚ₋₁ through the bypass line 58_{p/3}, and directly receives the voltage Vₚ₋₁ from the node TPₚ₋₁. The second terminal 57₂ is connected to the output terminal LVₚ₋₁. The third terminal 57₃ is connected to the output of the buffer amplifier AM_{p/3}. The output of the buffer amplifier AM_{p/3} is also directly connected to the output terminal LVₚ.

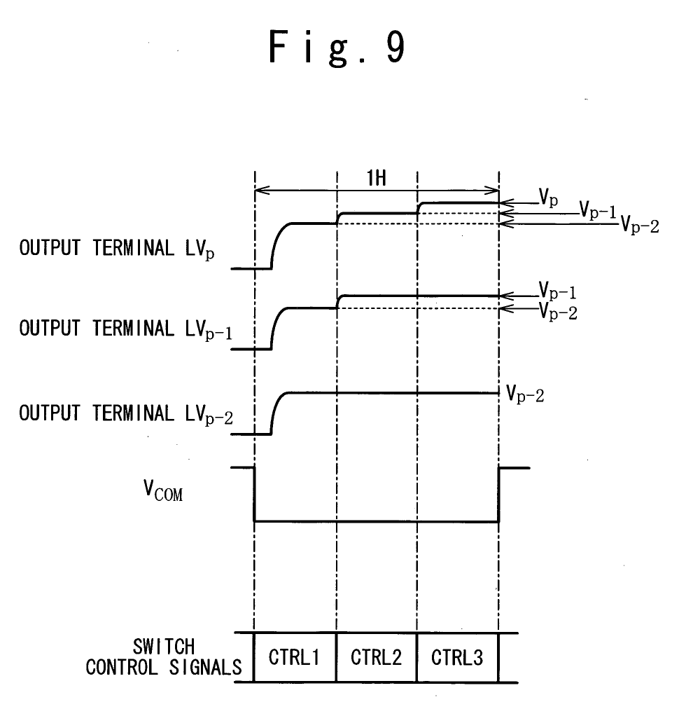

FIG. 9 is a timing chart illustrating an exemplary operation of the buffer module M_{p/2} and the switch control circuit 53.

When a horizontal period is initiated, as shown in FIG. 9, the horizontal sync signal S_{L} is activated, and the common voltage V_{COM} is switched on the common electrode of the LCD panel; the common voltage V_{COM} is pull down to ground in this operation.

In response to the activation of the horizontal sync signal S_{L}, the switch control circuit 53 switches the switch control signals provided for the input and output switch modules SWa and SWb within the buffer module M_{p/3} to a first state, referred to as the state “CTRL1”, at the beginning of the first one-third of the horizontal period.

In response to the associated switch control signal being placed into the state “CTRL1”, as shown in FIG. 8A, the switch 54 within the input switch module SWc connects the first terminal 54₁ with the fourth terminal 54₄, and thereby provides a connection between the node TPₚ₋₂ and the input of the buffer amplifier AM_{p/3}.

Additionally, the output switch module SWd connects the third terminal 56₃ with the second terminal 56₂ within the switch 56, and also connects the third terminal 57₃ with the second terminal 57₂ within the switch 57, in response to the associated switch control signal being placed into the state “CTRL1”. In other words, the output switch module SWd provides connections from the output of the buffer amplifier AM_{p/3} to the output terminals LVₚ₋₂ and LVₚ₋₁.

As shown in FIG. 9, this results in that all of the output terminals LVₚ₋₂, LVₚ₋₁, and LVₚ are driven to the voltage Vₚ₋₂ by the buffer amplifier AM_{p/3}, during the first one-third of the horizontal period.

The switch control circuit 53 then switches the switch control signals to a second state, referred to as the state “CTRL2”, at the beginning of the second one-third of the horizontal period.

In response to the associated switch control signal being switched to the state “CTRL2”, as shown in FIG. 8B, the switch 54 within the input switch module SWc connects the second terminal 54₂ with the fourth terminal 54₄, and thereby provides a connection between the node TPₚ₋₁ and the input of the buffer amplifier AM_{p/3}.

Additionally, the output switch module SWb connects the second terminal 56₂ with the first terminal 56₁ in place of the third terminal 56₃ within the switch 56, in response to the switch control signal being placed into the state “CTRL2”. In other words, the output switch module SWb provides a connection between the output terminal LVₚ₋₂ and the node TPₚ₋₂ through the bypass line 59_{p/3}, disconnecting the output of the buffer amplifier AM_{p/3} from the output terminal LVₚ₋₂.

As shown in FIG. 9, this results in that the output terminals LVₚ₋₁ and LVₚ is pulled up to the voltage Vₚ₋₁ from the voltage Vₚ₋₂ while the voltage developed on the output terminal LVₚ₋₂ is maintained at the voltage Vₚ₋₂ through connecting the output terminal LVₚ₋₂ to the node TPₚ₋₂ through the bypass line 59_{p/3}.

The switch control circuit 53 then switches the switch control signals to a third state, referred to as the state “CTRL3”, at the beginning of the final one-third of the horizontal period.

In response to the associated switch control signal being switched to the state “CTRL3”, as shown in FIG. 8C, the switch 54 within the input switch module SWc connects the third terminal 54₃ with the fourth terminal 54₄, and thereby provides a connection between the node TPₚ and the input of the buffer amplifier AM_{p/3}.

Additionally, the output switch module SWb connects the second terminal 57₂ with the first terminal 57₁ in place of the third terminal 57₃ within the switch 57, in response to the switch control signal being placed into the state “CTRL3”. In other words, the output switch module SWb provides a connection between the output terminal LVₚ₋₁ and the node TPₚ₋₁ through the bypass line 58_{p/3}, disconnecting the output of the buffer amplifier AM_{p/3} from the output terminal LVₚ₋₁.

As shown in FIG. 9, this results in that the output terminal LVₚ is pulled up to the voltage Vₚ from the voltage Vₚ₋₁, while the voltages developed on the output terminals LVₚ₋₂ and LVₚ₋₁ are maintained at the voltages Vₚ₋₂ and Vₚ₋₁, respectively.

It should be noted that the order in which the voltages Vₚ, Vₚ₋₁, and Vₚ₋₂ are developed on the outputs terminals LVₚ, LVₚ₋₁, and LVₚ₋₂ is preferably dependent on the level of the common voltage V_{COM}. As described above, for a horizontal period during which the common voltage V_{COM} is pulled down to ground, the input switch module SWc selects the voltage Vₚ₋₂ to output to the input of the buffer amplifier AM_{p/3} during the first one-third of the horizontal period, and then selects the voltage Vₚ₋₁ during the second one-third of the horizontal period, and finally selects the voltage Vₚ during the final one-third of the horizontal period.

For a horizontal period during which the common voltage V_{COM} is pulled up to a power supply voltage, higher than the voltage Vₙ, the order in which the voltages Vₚ, Vₚ₋₁, and Vₚ₋₂ are selected by the input switch module SWc is reversed.

Specifically, the input switch module SWc selects the voltage Vₚ during the first one-third of the horizontal period, while the output switch module SWb provides connections between the output of the buffer amplifier AM_{j/2} and all of the output terminals LVₚ₋₂, LVₚ₋₁, and LVₚ. This results in that all of the output terminals LVₚ₋₂, LVₚ₋₁, and LVₚ are driven to the voltage Vₚ.

During the second one-third of the horizontal period, the input switch module SWc selects the voltage Vₚ₋₁, while the output switch module SWd provides a connection between only the output terminals LVₚ₋₁ and LVₚ₋₂ and the output of the buffer amplifier AM_{p/2}; the output terminal LVₚ is disconnected from the output of the buffer amplifier AM_{p/3}, and connected to the node LVₚ through an additional bypass line. This results in that the output terminals LVₚ₋₂ and LVₚ₋₁ are driven down to the voltage Vₚ₋₁, with the output terminal LVₚ maintained at the voltage Vₚ.

During the final one-third of the horizontal period, the input switch module SWc selects the voltage Vₚ₋₂, while the output switch module SWd provides a connection between only the output terminal LVₚ₋₂ and the output of the buffer amplifier AM_{p/2}; the output terminal LVₚ₋₁ is additionally disconnected from the output of the buffer amplifier AM_{p/3}, and connected to the node LVₚ₋₁ through the bypass line 58_{p/3}. This results in that the output terminals LVₚ₋₂ is driven down to the voltage Vₚ₋₂ with the output terminals LVₚ and LVₚ₋₁ maintained at the voltages Vₚ and Vₚ₋₁, respectively.

In an alternative embodiment, each horizontal period may be divided into first to third time periods having durations different from the aforementioned embodiment; the first time period, which initiates at the beginning of the horizontal period has a longer duration than those of the following second and third time periods. Specifically, for a horizontal period during which the common voltage V_{COM} is pulled down to ground, the first time period, during which all of the output terminals LVₚ₋₂, LVₚ₋₁, and LVₚ are driven to the voltage Vₚ₋₂ preferably has a duration longer than the following time periods during which the output terminals LVₚ₋₁ and LVₚ are driven to the voltages Vₚ₋₁ and Vₚ, respectively. Correspondingly, for a horizontal period during which the common voltage V_{COM} is pulled up to the power supply voltage, the first time period during which all of the output terminals LVₚ₋₂, LVₚ₋₁, and LVₚ are driven to the voltage Vₚ preferably has a duration longer than those of the following two time periods during which the output terminals LVₚ₋₁ and LVₚ₋₂ are driven to the voltages Vₚ₋₁ and Vₚ₋₂, respectively. In one preferred embodiment, the first time period has a duration equal to the half of the horizontal period (½H), and the second and third time periods each have a duration equal to one-fourth of the horizontal period (¼H).

This operation addresses providing the buffer amplifier AM_{p/3} with sufficient time for driving the output terminals LVₚ₋₂, LVₚ₋₁, and LVₚ to the voltage Vₚ₋₂ (or Vₚ) at the beginning of the horizontal period. As is understood from FIG. 9, the buffer amplifier AM_{p/3} requires a longer duration for the drive of the output terminals LVₚ₋₂. LVₚ₋₁, and LVₚ to the voltage Vₚ₋₂ (or Vₚ) compared to the following drives up to the voltages Vₚ₋₁ and Vₚ (or down to the voltages Vₚ₋₁ and Vₚ₋₂).

The above-described LCD driver architecture in this embodiment provides the same advantages as that disclosed in the first embodiment. The LCD driver architecture in this embodiment is also effective for reducing the power consumption and circuit size through reducing the number of necessary buffer amplifiers. Additionally, the LCD driver architecture in this embodiment effectively avoids over-shoot of the voltages on the output terminals of the drive voltage generator circuit 50 through adopting step-by-step driving.

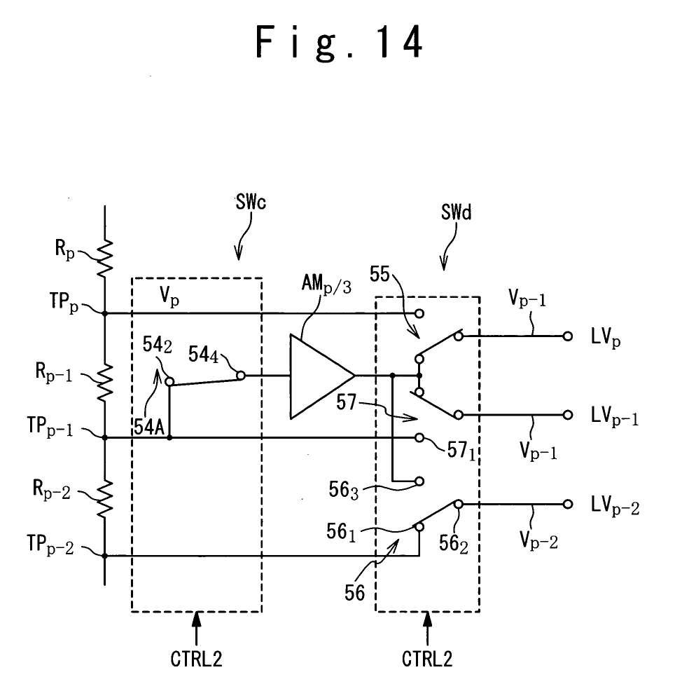

In another alternative embodiment, the structure of the input and output switch modules SWc and SWd of the buffer module M_{p/3} may be modified as shown in FIG. 14. In the structure shown in FIG. 14, the input switch module SWc within the buffer module M_{p/3} is composed of a switch 54A that is responsive to the control signal received from the switch control circuit 43 for providing an electrical connection between the node TPₚ₋₁ and the input of the buffer amplifier AM_{p/2}. The output switch module SWd additionally includes a switch 55 that is responsive to the control signal received from the switch control circuit 53 for electrically connecting selected one of the input of the buffer amplifier AM_{p/3} and the node TPₚ to the output terminal LVₚ.

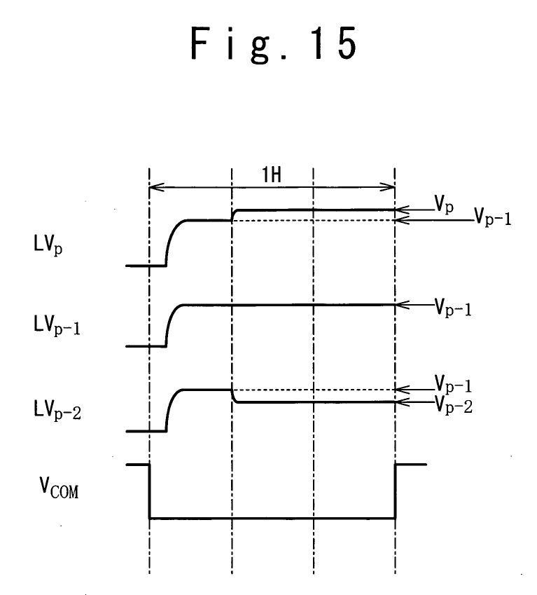

FIG. 15 is a timing chart illustrating an exemplary operation of the buffer module M_{p/3} of FIG. 14. The operation of the buffer module M_{p/3} of FIG. 14 divides each horizontal period into first and second periods; the first period begins at the beginning of each horizontal period, and the second period follows the first period.

During the first period, the switch 54A within the input switch module SWc establishes an electrical connection between the node TPₚ₋₁ to the input of the buffer amplifier AM_{p/3}, and the output switch module SWd establishes electrical connections between the output of the buffer amplifier AM_{p/3} and all of the output terminals LVₚ₋₂, LVₚ₋₂, and LVₚ. This results in that all of the output terminals LVₚ, LVₚ₋₁ and LVₚ₋₂ are driven to the voltage Vₚ₋₁ by the buffer amplifier AM_{p/3}, during the first period.

During the second period, the switch 54A disconnects the node TVₚ₋₁ from the input of the buffer amplifier AM_{p/3}. The switches 55, 56, and 57 electrically connect the nodes TPₚ₋₂, TPₚ₋₁, and TPₚ to and the corresponding output terminals LVₚ₋₂, LVₚ₋₁, and LVₚ, respectively; the output of the buffer amplifier AM_{p/3} is disconnected from all of the output terminals LVₚ₋₂, LVₚ₋₁, and LVₚ. This results in that the output terminal LVₚ₋₂ is driven down to the voltage Vₚ₋₂ and the output terminal LVₚ is driven up to the voltage Vₚ; the output terminal LVₚ₋₁ is maintained at the voltage Vₚ.

This operation advantageously achieves further reduction in the power consumption. The aforementioned operation allows the buffer amplifier AM_{p/2} to be disenabled during the second period. This effectively reduces the power consumption of the buffer module M_{p/2}.

It is important that the output terminals LVₚ₋₂ to LVₚ are firstly driven to the voltage Vₚ₋₁, which is an intermediate voltage between the voltages Vₚ₋₂, and Vₚ. Firstly driving the output terminals LVₚ₋₂ to LVₚ to the voltage Vₚ₋₁ is effective for reducing the number of the driving steps; this operation requires only two steps for driving the three output terminals LVₚ₋₂ to LVₚ.

It is preferable that the duration of the second period, during which the buffer amplifier AM_{p/2} is disconnected from both of the output terminals LVₚ₋₂ to and LVₚ, is longer than that of the first period. This is because driving the output terminals LVₚ₋₂ and LVₚ to the voltages Vₚ₋₂ and Vₚ, respectively, without using the buffer amplifier AM_{p/2} requires longer duration compared to the duration necessary for driving the output terminals LVₚ₋₂ to LVₚ using the buffer amplifier AM_{p/3}. In an exemplary operation, the duration of the first period is one-fifth of that of the horizontal period, while the duration of the second period is four-fifth of that of the horizontal period.

### Third Embodiment

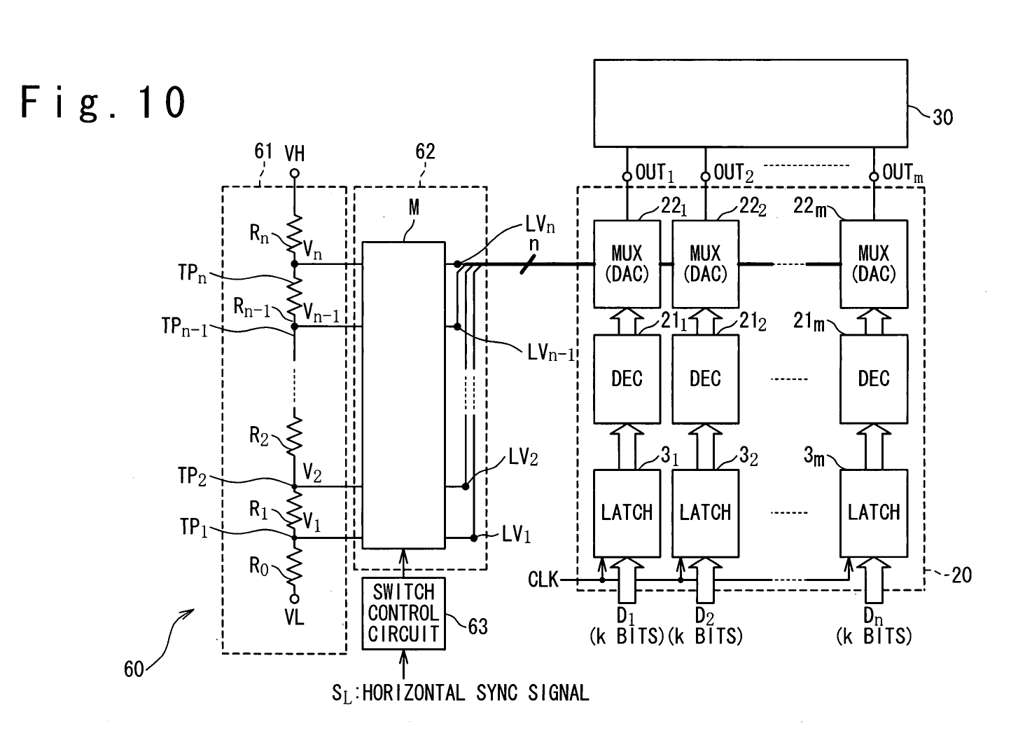

FIG. 10 illustrates an exemplary structure of a liquid crystal display apparatus in a third embodiment. The structure liquid crystal display apparatus in the third embodiment is similar to that in the first embodiment, except for that the arrangement of the drive voltage generator circuit, denoted by numeral 60. The major difference is that the drive voltage generator circuit 60 uses one buffer amplifier for driving all of the output terminals LV₁ to LVₙ. A detailed description of an exemplary structure and operation of the drive voltage generator circuit 60 is given in the following.

The drive voltage generator circuit 60 is composed of a breeder 61, a buffer circuitry 62, and a switch control circuit 63.

The breeder 61 is comprised of a set of serially connected resistors R₀ to Rₙ between the power supply V_{H} and ground V_{L} to generate n different voltages associated with grayscale levels; n being the number of available grayscale levels, equal to 2^{k}, where the k is the number of data bits of each pixel data. The resistor element Rᵢ is connected to the adjacent resistor element Rᵢ₋₁ with a node TPᵢ disposed therebetween, where i is any integer ranging from 1 to n. Such connection provides different voltages V₁ to Vₙ on the nodes TP₁ to TPₙ. It should be noted that the voltages V₁ to Vₙ satisfy the following relation:
V₁<V₂< . . . <Vₙ.

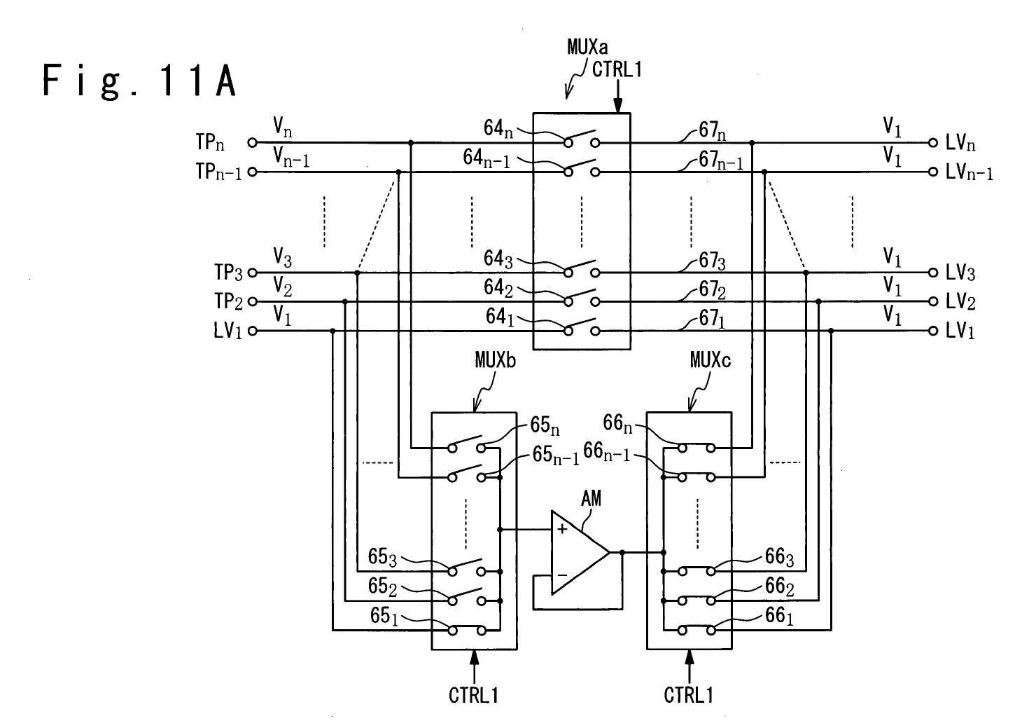

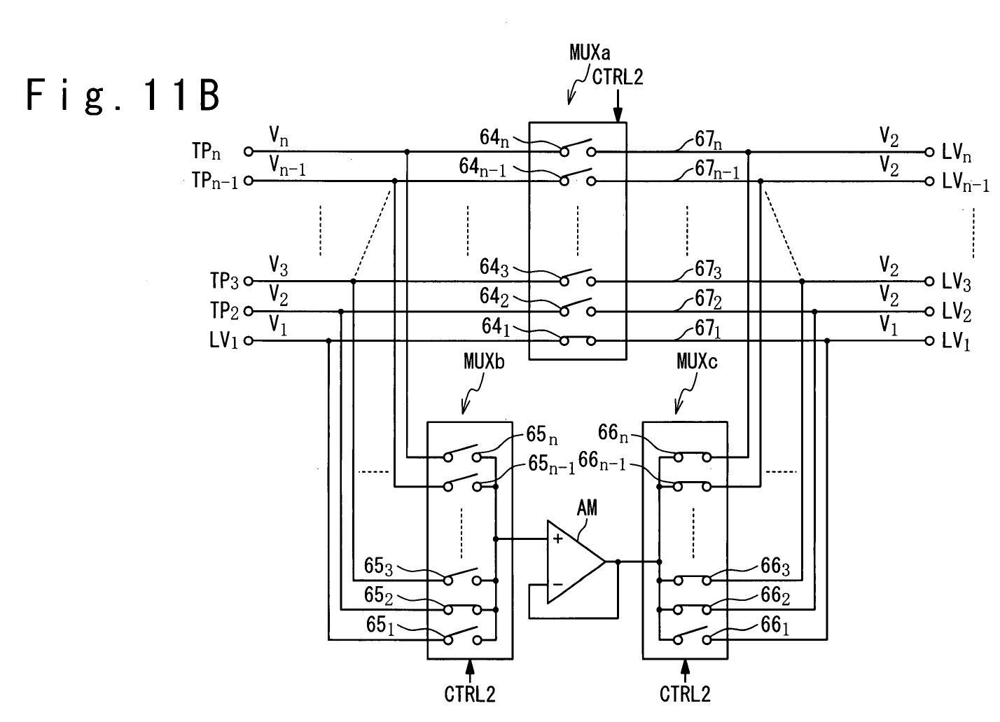

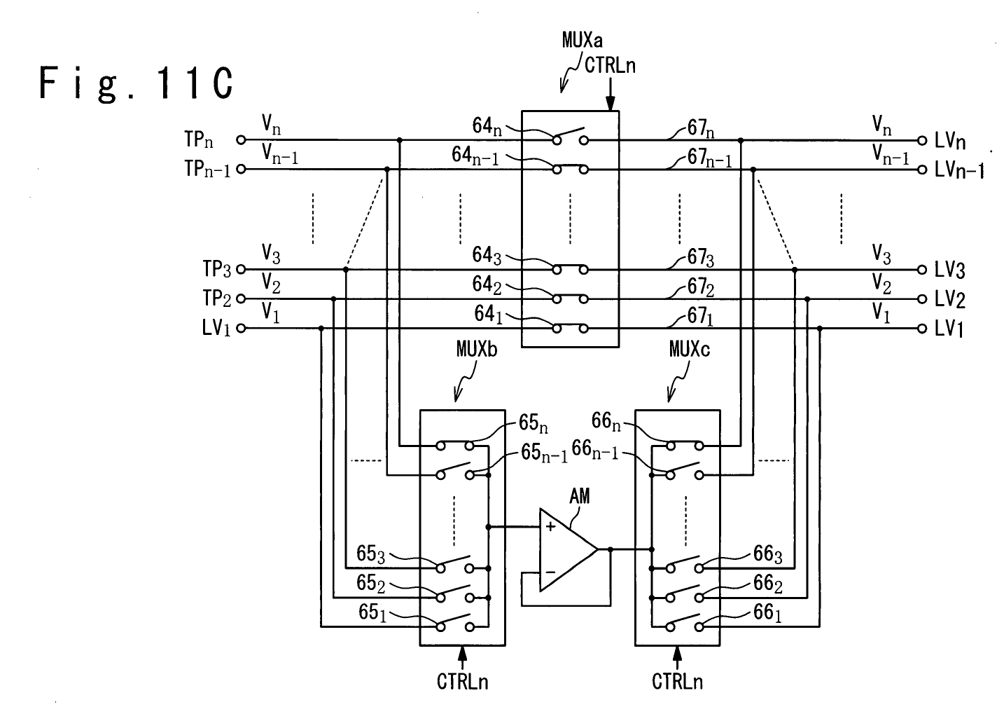

The buffer circuitry 62 is composed of a single buffer module M. As shown in FIGS. 11A to 11C, the buffer module M is composed of a bypass multiplexer MUXa, an input multiplexer MUXb, an output multiplexer MUXc, and one buffer amplifier AM having a gain of 1.

The bypass multiplexer MUXa is inserted into a set of bypass lines 67₁ to 67ₙ connected between the nodes TP₁ to TPₙ and the output terminals LV₁ to LVₙ. The bypass multiplexer MUXa is composed of a set of switches 64₁ to 64ₙ that are disposed between the nodes TP₁ to TPₙ and the output terminals LV₁ to LVₙ, respectively. The bypass multiplexer MUXa are designed to receive the voltages V₁ to Vₙ from the nodes TP₁ to TPₙ, and to transfer selected one(s) of the voltages V₁ to Vₙ to the associated one(s) of the output terminals LV₁ to LVₙ.

The input multiplexer MUXb is connected between the nodes TP₁ to TPₙ and the input of the buffer amplifier AM. The input multiplexer MUXb is composed of a set of switches 65₁ to 65ₙ connected between the input of the buffer amplifier AM, and the nodes TP₁ to TPₙ respectively. The input multiplexer MUXb is designed to provide selected one of the voltages V₁ to Vₙ to the input of the buffer amplifier AM.

The output multiplexer MUXc is connected between the output of the buffer amplifier AM and the output terminals LV₁ to LVₙ. The output multiplexer MUXc is composed of a set of switches 66₁ to 66ₙ connected between the output of the buffer amplifier AM, and the output terminals LV₁ to LVₙ, respectively. The output multiplexer MUXc is designed to connect the output of the buffer amplifier AM with selected one(s) of the output terminals LV₁ to LVₙ, which are connected to the drive circuitry 20.

The switch control circuit 63 is responsive to an externally inputted horizontal sync signal S_{L} for providing a switch control signal for each of the bypass, input, and output multiplexers MUXa, MUXb and MUXc. The bypass multiplexer MUXa is responsive to the switch control signal received from the switch control circuit 63 for switching connections between the nodes TP₁ to TPₙ and the output terminals LV₁ to LVₙ. Correspondingly, the input multiplexer MUXb is responsive to the switch control signal received from the switch control circuit 63 for switching connections between the nodes TP₁ to TPₙ and the input of the buffer amplifier AM, while the output multiplexer MUXc is responsive to the switch control signal received from the switch control circuit 63 for switching connections between the output of the buffer amplifier AM and the output terminals LV₁ to LVₙ.

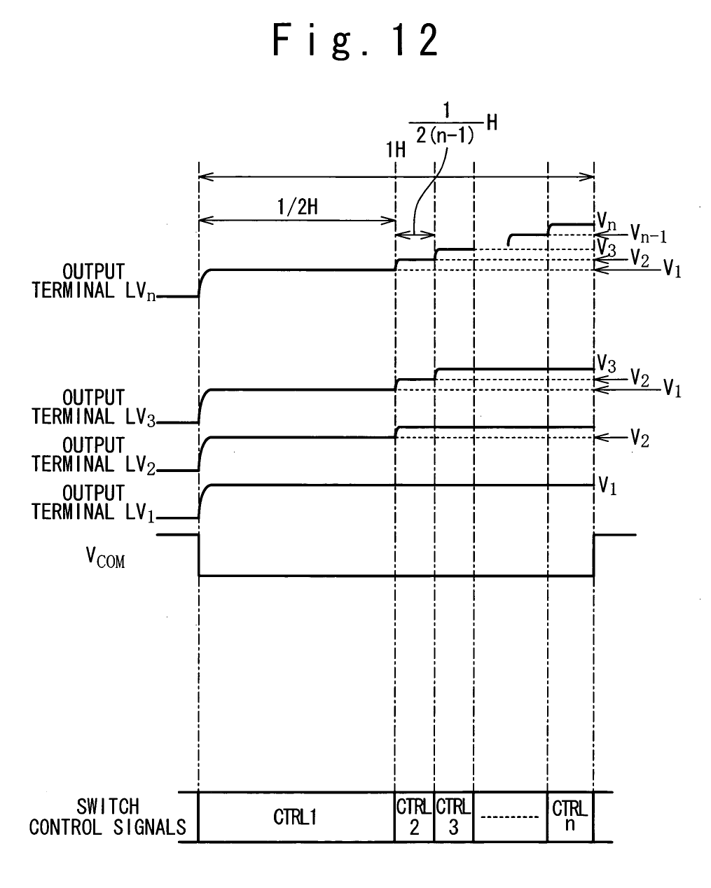

FIG. 12 is a timing chart illustrating an exemplary operation of the buffer module M and the switch control circuit 63. The operation in this embodiment divides each horizontal period into first to n-th time periods so that the first time period has a duration longer than the following time periods. As described later, this is effective for providing the buffer amplifier AM with efficient time for driving the output terminals LV₁ to LVₙ. In one embodiment, the first time period has a duration equal to the half of the horizontal period (½H), and the remaining time periods (that is, the second to n-th time periods) has a duration of ½(n−1) times the horizontal period (½(n−1)H).

At the beginning of the first time period, as shown in FIG. 12, the horizontal sync signal S_{L} is activated, and the common voltage V_{COM} is switched on the common electrode of the LCD panel 30; the common voltage V_{COM} is pull down to ground in this operation.

In response to the activation of the horizontal sync signal S_{L}, the switch control circuit 63 switches the switch control signals provided for the bypass, input, and output multiplexers MUXa, MUXb, and MUXc to a first state, referred to as the state “CTRL1”, at the beginning of the first time period within the horizontal period.

In response to the switch control signals being placed into the state “CTRL1”, as shown in FIG. 11A, the bypass, input, and output multiplexers MUXa, MUXb, and MUXc switch connections among the nodes TP₁ to TPₙ, the buffer amplifier AM, and the output terminals LV₁ to LVₙ. Specifically, the input multiplexer MUXb connects the node TP₁, on which the voltage V₁ is developed, to the input of the buffer amplifier AM, and the output multiplexer MUXc connects the output of the buffer amplifier AM to all of the output terminals LV₁ to LVₙ. Additionally, the bypass multiplexer MUXa disconnects all of the nodes TP₁ to TPₙ from the output terminals LV₁ to LVₙ.

As shown in FIG. 12, this results in that all of the output terminals LV₁ to LVₙ are driven up to the voltage V₁ by the buffer amplifier AM, during the first time period within the horizontal period.

The switch control circuit 63 then switches the switch control signals to a second state, referred to as the state “CTRL2”, at the beginning of the second time period within the horizontal period.

In response to the switch control signals being placed into the state “CTRL2”, as shown in FIG. 11B, the bypass, input, and output multiplexer MUXa, MUXb, and MUXc then switch connections among the nodes TP₁ to TPₙ, the buffer amplifier AM, and the output terminals LV₁ to LVₙ, as described in the following: The input multiplexer MUXb connects the node TP₂, on which the voltage V₂ is developed, to the input of the buffer amplifier AM, disconnecting the remaining nodes TP1, and TP3 to TPn from the input of the buffer amplifier AM. The output multiplexer MUXc connects the output of the buffer amplifier AM to the output terminals LV₂ to LVₙ, disconnecting the output terminal LV₁ from the output of the buffer amplifier AM. Additionally, the bypass multiplexer MUXa connects the node TP₁ to the output terminal LV₁, disconnecting the remaining nodes TP₂ to TPₙ from the remaining output terminals LV₂ to LVₙ.

As shown in FIG. 12, this results in that the output terminals LV₂ to LVₙ are driven up to the voltage V₂ by the buffer amplifier AM during the first time period within the horizontal period, while the output terminal LV₁ is maintained at the voltage V₁.

The same goes for the following time periods. At the beginning of the i-th time period, the switch control circuit 63 switches the switch control signals to the i-th state “CTRLi”; i is any integer ranging from 3 to n. In response to the switching of the switch control signals, the bypass multiplexer MUXa, the input multiplexer MUXb, the output multiplexer MUXc then switch connections among the nodes TP₁ to TPₙ, the buffer amplifier AM, and the output terminals LV₁ to LVₙ. Specifically, the input multiplexer MUXb connects the node TPᵢ, on which the voltage Vᵢ is developed, to the input of the buffer amplifier AM, disconnecting the remaining nodes from the input of the buffer amplifier AM. The output multiplexer MUXc connects the output of the buffer amplifier AM to the output terminals LVᵢ to LVₙ, disconnecting the output terminals LV₁ to LVᵢ₋₁ from the output of the buffer amplifier AM. Additionally, the bypass multiplexer MUXa connects the nodes TP₁ to TPᵢ₋₁ to the output terminals LV₁ to LVᵢ₋₁, respectively, disconnecting the remaining nodes TPᵢ to TPₙ from the remaining output terminals LVᵢ to LVₙ.

As shown in FIG. 12, this results in that the output terminals LVᵢ to LVₙ are driven up to the voltage Vᵢ by the buffer amplifier AM during the i-th time period within the horizontal period, while the output terminals LV₁ to LVᵢ₋₁ are maintained at the voltages V₁ to Vᵢ₋₁, respectively.

As illustrated in FIG. 11C, this procedure eventually provides the voltages V₁ to Vₙ on the output terminals LV₁ to LVₙ, respectively, during the final n-th time period.

It should be noted that the order in which the voltages V₁ to Vₙ are developed on the outputs terminals LV₁ to LVₙ is preferably dependent on the level of the common voltage V_{COM}. As described above, for a horizontal period during which the common voltage V_{COM} is pulled down to ground, the buffer module M develops the voltage V₁ on all of the output terminals V₁ to Vₙ during the first time period, and then develops the voltage V₂ on the output terminals V₂ to Vₙ with the output terminal V₁ maintained at the voltage V₁, during the second time period. The same goes for the following time period.

For a horizontal period during which the common voltage V_{COM} is pulled up to a power supply voltage, higher than the voltage Vₙ, the order in which the voltages V₁ to Vₙ are developed on the outputs terminals LV₁ to LVₙ is reversed.

Specifically, during the first time period, the input multiplexer MUXb connects the node TPₙ, on which the voltage Vₙ is developed, to the input of the buffer amplifier AM, disconnecting the remaining nodes TP₁ to TPₙ₋₁ from the input of the buffer amplifier AM. The output multiplexer MUXc connects the output of the buffer amplifier AM to all of the output terminals LV₁ to LVₙ. Additionally, the bypass multiplexer MUXa disconnects all of the nodes TP₁ to TPₙ from the output terminals LV₁ to LVₙ. This results in that all of the output terminals LV₁ to LVₙ are driven to the voltage Vₙ.

During the second time period, the input multiplexer MUXb connects the node TPₙ₋₁, on which the voltage Vₙ₋₁ is developed, to the input of the buffer amplifier AM, disconnecting the remaining nodes TP₁ to TPₙ₋₂, and TPₙ from the input of the buffer amplifier AM. The output multiplexer MUXc connects the output of the buffer amplifier AM to the output terminals LV₁ to LVₙ₋₁, disconnecting the output terminal LVₙ from the output of the buffer amplifier AM. Additionally, the bypass multiplexer MUXa connects the node TPₙ to the output terminal LVₙ, disconnecting the remaining nodes TP₁ to TPₙ₋₁ from the remaining output terminals LV₁ to LVₙ₋₁. This results in that the output terminals LV₁ to LVₙ₋₁ are driven down to the voltage Vₙ₋₁, with the output terminal LVₙ maintained at the voltage Vₙ.

The same goes for the following time period. During the i-th time period with i being any integer ranging from 3 to n, the input multiplexer MUXb connects the node TPₙ₋ᵢ₊1, on which the voltage Vₙ₋ᵢ₊1 is developed, to the input of the buffer amplifier AM, disconnecting the remaining nodes TP₁ to TPₙ₋ᵢ, and TPₙ₋ᵢ₊₂ to TPₙ from the input of the buffer amplifier AM. The output multiplexer MUXc connects the output of the buffer amplifier AM to the output terminals LV₁ to LVₙ₋ᵢ₊₁, disconnecting the output terminals LVₙ₋₁₊₂ to LVₙ from the output of the buffer amplifier AM. Additionally, the bypass multiplexer MUXa connects the node TPₙ₋₁₊₂ to TP₁ to the output terminals TPₙ₋ᵢ₊₂ to TPₙ, disconnecting the remaining nodes TP₁ to TPₙ₋ᵢ₊₁ from the remaining output terminals TP₁ to TPₙ₋ᵢ₊₁. This results in that the output terminals LV₁ to LVₙ₋ᵢ₊₁ are driven down to the voltage Vₙ₋ᵢ₊₁, with the output terminals TPₙ₋ᵢ₊₂ to TPₙ maintained at the voltages Vₙ₋ᵢ₊₂ to Vₙ, respectively.

Although the invention has been described in its preferred form with a certain degree of particularity, it is understood that the present disclosure of the preferred form has been changed in the details of construction and the combination and arrangement of parts may be resorted to without departing from the scope of the invention as hereinafter claimed.

Especially, it should be noted that the buffer circuitry architecture shown in FIGS. 11A to 11C is applicable to the buffer modules M₁ to M_{n/2} shown in FIG. 4, and also applicable to the buffer modules M₁ to M_{(n-α)/3} shown in FIG. 7. Those skilled in the art would appreciate that the buffer circuitry shown in FIGS. 11A to 11C with n=2 provides the same function as each buffer modules M_{j/2} shown in FIG. 4, and the buffer circuitry shown in FIGS. 11A to 11C with n=3 provides the same function as each buffer module M_{p/3} shown in FIG. 7.

1. A drive voltage generator circuit comprising:
a breeder developing a set of first to N-th different voltages on first to N-th nodes, respectively, N being any integer equal to or more than 2, and said first to N-th voltages being associated with grayscale levels, respectively;
a buffer amplifier;
a set of first to N-th output terminals through which drive voltages are provided for an LCD panel; and
a switch circuitry that switches connections among an input and an output of said buffer amplifier, said first to N-th nodes, and said first to N-th output terminals.

2. The drive voltage generator circuit according to claim 1, wherein, during a first time period, said switch circuitry connects said first node to said input of said buffer amplifier, and connects said output of said buffer amplifier to all of said first to N-th output terminals, and
wherein, during a second time period following said first time period, said switch circuitry connects said second node to said input of said buffer amplifier, and connects said output of said buffer amplifier to said second to N-th output terminals, disconnecting said output of said buffer amplifier from said first output terminal.

3. The drive voltage generator circuit according to claim 2, wherein said switch circuitry connects said first node to said first output terminal during said first time period.

4. The drive voltage generator circuit according to claim 2, wherein, during i-th time period with i being any integer ranging from 2 to N, said switch circuitry connects said i-th node to said input of said buffer amplifier, and connects said output of said buffer amplifier to said i-th to N-th output terminals, disconnecting said first to (i−1)-th output terminals from said output of said buffer amplifier.

5. The drive voltage generator circuit according to claim 4, wherein said switch circuitry connects said first to (i-1)-th nodes to said first to (i-1)-th output terminals, respectively, during said i-th time period.

6. The drive voltage generator circuit according to claim 2, wherein said first time period has a duration longer than that of said second time period.

7. The drive voltage generator circuit according to claim 4, wherein said first time period has a duration longer than those of said second to N-th time periods.

8. The drive voltage generator circuit according to claim 1, wherein said switch circuitry includes:
an input switch module that switches said input of said buffer amplifier to selected one of said first and second voltages, and
an output switch module,
wherein said output switch module connects said output of said buffer amplifier to said first and second output terminals during a first time period, and
wherein, during a second time period following said first time period, said output switch module connects said output of said buffer amplifier to said second output terminal with said output of said buffer amplifier disconnected from said first output terminal, and connects said first output terminal to said first node.

9. The drive voltage generator circuit according to claim 8, wherein said switch circuitry further includes an input switch module,
wherein said input switch module connects said first node to said input of said buffer amplifier during said first time period, and connects said second node to said input of said buffer amplifier during said second time period.

10. The drive voltage generator circuit according to claim 1, wherein said switch circuitry includes:
an input switch module that switches said input of said buffer amplifier to selected one of said first to third voltages, and
an output switch module,
wherein said output switch module connects said output of said buffer amplifier to said first to third output terminals during a first time period,
wherein, during a second time period following said first time period, said output switch module connects said output of said buffer amplifier to said second and third output terminals with said output of said buffer amplifier disconnected from said first output terminal, and connects said first output terminal to said first node, and
wherein, during a third time period following said second time period, said output switch module connects said output of said buffer amplifier to said third output terminal with said output of said buffer amplifier disconnected from said first and second output terminals, and connects said first and second output terminals to said first and second nodes, respectively.

11. The drive voltage generator circuit according to claim 10, wherein said input switch module connects said first node to said input of said buffer amplifier during said first time period, connects said second node to said input of said buffer amplifier during said second time period, and connects said third node to said to said input of said buffer amplifier during said third time period, respectively.

12. The drive voltage generator circuit according to claim 1, wherein said switch circuitry includes:
an input multiplexer module for connecting selected one of said first to N-th node to said input of said buffer amplifier,
an output multiplexer module for connecting said output of said buffer amplifier to selected one(s) of said first to N-th output terminals, and
a bypass multiplexer module for connecting selected one(s) of said first to N-th node to associated one(s) of said first to N-th output terminals.

13. The drive voltage generator circuit according to claim 12, wherein a first time period, said input multiplexer module connects said first node to said input of said buffer amplifier, and said output multiplexer module connects said output of said buffer amplifier to all of said first to N-th output terminals, and said bypass multiplexer module disconnects said first to N-th nodes from said first to N-th output terminals, and
wherein, during an i-th time period with i being any integer ranging from 2 to N, said input multiplexer module connects said i-th node TPᵢ to said input of said buffer amplifier, and said output multiplexer module connects said output of said buffer amplifier to said i-th to N-th output terminals, disconnecting said first to (i-1)-th output terminals from said output of said buffer amplifier, and said bypass multiplexer module connects said first to (i-1)-th nodes to said first to (i-1)-th output terminals, respectively, disconnecting said i-th to N-th nodes from said i-th to N-th output terminals.

14. The drive voltage generator circuit according to claim 1, wherein each horizontal period is divided into first to N-th time periods,
wherein said first to N-th voltages satisfy the following relation:
V₁<V₂< . . . <V_{N},
where Vᵢ is a level of said i-th voltage,
wherein, during a first time period within a first horizontal period during which a common electrode within said LCD panel is pulled down to ground, said switch circuitry connects said first node to said input of said buffer amplifier, and connects said output of said buffer amplifier to all of said first to N-th output terminals,
wherein, during an i-th time period within said first horizontal period with i being any integer ranging from 2 to N, said switch circuitry connects said i-th node to said input of said buffer amplifier, connects said output of said buffer amplifier to said i-th to N-th output terminals, disconnecting said first to (i-1)-th output terminals from said output of said buffer amplifier, and connects said first to (i-1)-th nodes to said first to (i-1)-th output terminals, respectively,
wherein, during a first time period within a second horizontal period during which a common electrode within said LCD panel is pulled up to a voltage, said switch circuitry connects said N-th node to said input of said buffer amplifier, and connects said output of said buffer amplifier to all of said first to N-th output terminals, and
wherein, during an i-th time period within said second horizontal period, said switch circuitry connects said (N-i+1)-th node to said input of the buffer amplifier, connects the output of the buffer amplifier to said first to (N-i+1)-th output terminals, disconnecting said (N-i+2)-th to N-th output terminals from said output of the buffer amplifier, and connects said (N-i+2)-th to N-th nodes to said (N-i+2)-th to N-th terminals.

15. An LCD driver comprising:
a drive voltage generator circuit developing a set of drive voltages on n output terminals, respectively, n being any integer equal to or more than 2; and
an output selector circuit designed to select one of said drive voltages in response to pixel data, and to output said selected drive voltage to associated one of signal lines within an LCD panel;
wherein said drive voltage generator circuit includes:
a breeder developing a set of n different voltages on n nodes, respectively, and said n different voltages being associated with n different grayscale levels, respectively,
a buffer amplifier, and
a switch circuitry,
wherein said n output terminals includes a set of first to N-th output terminals, N being an integer selected between 2 and n,
wherein said set of n different voltages includes a set of first to N-th voltages, and said n nodes includes a set of first to N-th nodes, and
wherein said switch circuitry switches connections among an input and an output of said buffer amplifier, said first to N-th nodes, and said first to N-th output terminals.

16. The drive voltage generator circuit according to claim 15, wherein, during a first time period, said switch circuitry connects said first node to said input of said buffer amplifier, and connects said output of said buffer amplifier to all of said first to N-th output terminals, and
wherein, during a second time period following said first time period, said switch circuitry connects said second node to said input of said buffer amplifier, and connects said output of said buffer amplifier to said second to N-th output terminals, disconnecting said output of said buffer amplifier from said first output terminal.

17. The drive voltage generator circuit according to claim 16, wherein said switch circuitry connects said first node to said first output terminal during said first time period.

18. The drive voltage generator circuit according to claim 16, wherein, during i-th time period with i being any integer ranging from 2 to N, said switch circuitry connects said i-th node to said input of said buffer amplifier, and connects said output of said buffer amplifier to said i-th to N-th output terminals, disconnecting said first to (i-1)-th output terminals from said output of said buffer amplifier.

19. The drive voltage generator circuit according to claim 18, wherein said switch circuitry connects said first to (i-1)-th nodes to said first to (i-1)-th output terminals, respectively, during said i-th time period.

20. The drive voltage generator circuit according to claim 16, wherein said first time period has a duration longer than that of said second time period.

21. The drive voltage generator circuit according to claim 18, wherein said first time period has a duration longer than those of said second to N-th time periods.

22. A liquid crystal display apparatus comprising:
an LCD panel including signal lines;
a drive voltage generator circuit developing a set of drive voltages on n output terminals, respectively, n being any integer equal to or more than 2; and
an output selector circuit designed to select one of said drive voltages in response to pixel data, and to output said selected drive voltage to associated one of said signal lines;
wherein said drive voltage generator circuit includes:
a breeder developing a set of n different voltages on n nodes, respectively, and said n voltages being associated with n grayscale levels, respectively,
a buffer amplifier, and
a switch circuitry,
wherein said n output terminals includes a set of first to N-th output terminals, N being an integer selected between 2 and n,
wherein said set of n different voltages includes a set of first to N-th voltages, and said n nodes includes a set of first to N-th nodes, and
wherein said switch circuitry switches connections among an input and an output of said buffer amplifier, said first to N-th nodes, and said first to N-th output terminals.
